(19) United States
(12) Patent Application Publication
(10) Pub. No.: US 2012/0268388 A1
(43) Pub. Date: Oct. 25, 2012

(54) TOUCH SCREEN TEXT SELECTION

(76) Inventor: Mahmoud Razzaghi, Chula Vista, CA (US)

(21) Appl. No.: 13/091,140

(22) Filed: Apr. 21, 2011

(51) Int. Cl. G06F 3/041

(52) U.S. Cl. 345/173

(57) ABSTRACT

A touch screen text input and selection system for cell phones and computers that allows the user to select characters on a virtual keyboard for inputting, and in a text box for editing without blocking the view of characters by the touching finger. An area adjacent to and below each character displayed on the virtual keyboard or in the text box is mapped to address the respective character. The user touches the area adjacent to and below a character displayed on the virtual keyboard or in the text box to select that character. Similarly, the user can place a cursor in the space between two characters by touching the area below that space. Double tapping an area below a word in the text box selects that word. Sliding finger below a series of characters in the text box selects those characters.

### FIELD OF THE INVENTION

This invention relates to touch screen text input and virtual keyboards for computers, cell phones, and electronic devices.

### BACKGROUND OF THE INVENTION

In touch screen computer interface, characters are addressed by the location they are displayed whether they are on the virtual keyboard or in the text box. A character on the virtual keyboard may have a broader address area defined by the border of the key surrounding it.

In the relatively small cell phone virtual keyboard, as the finger approaches a desired key, it blocks the view of the desired key and other adjacent keys, which interrupts the feedback required for proper positioning of the finger. This causes user confusion and discomfort resulting in slow typing speed and increased typing error.

As a solution to this problem, a pop up key shows the selected key. However, the user needs to do the extra task of looking away from the location of the finger to see the pop up key. Also, to navigate to the desired key, the user must move finger in a trial and error form. These two extra tasks for every key input substantially reduce typing speed.

Many users directly aim and tap in an effort to enter the desired key in one movement and without attention to the pop up feedback. This increases typing speed but at the same time increases typing error.

Also, the minimum key size requirement in relation to finger size limits the number of keys. Therefore, numeric and punctuation keys are provided in a separate keyboard. The user must toggle between the two keyboards which reduces typing speed.

Some virtual keyboards use one key to input multiple characters. However, the arrangement requires special attention and longer touch time to select the additional characters. Besides, due to lack of space, the size of characters displayed on the keys becomes too small for easy viewing.

In larger touch screens, the virtual keyboard can have large keys, but this will require large movements of the arm and hand, which substantially reduces typing speed.

Similarly, the selection of characters, or words, or placing the cursor between characters requires touching the same desired location, and consequently, blocking its view. This interrupts the feedback required for the user to do the task properly.

Especially, placing the cursor between two characters becomes a real challenge and impractical. As a way around this problem, Apple iPhone provides a pop up above the text that shows the zoomed text under the finger. However, a more direct way of solving the problem is desirable.

### OBJECTS OF THE INVENTION

Therefore, the object of the invention is to provide a touch screen text input and selection system with the following improvements:
1. Provide direct view of the desired key during typing with small virtual keyboards.
2. Provide additional space for individual numeric or punctuation keys on same virtual keyboards without compromising the space for finger touch.
3. Improve typing speed and accuracy.
4. Provide direct view of the characters during editing in the text box.
5. Improve text editing speed and accuracy.

### DESCRIPTION OF THE DRAWINGS

FIG. 1 shows the first embodiment of the invention.

FIG. 2 shows the second embodiment of the invention.

FIG. 3 shows the third embodiment of the invention.

### BRIEF DESCRIPTION OF THE INVENTION

The invention discloses a touch screen text input and selection system for cell phones and computers that allows the user to select characters on a virtual keyboard for inputting, and in a text box for editing without blocking the view of characters by the touching finger.

An area adjacent to and below each character displayed on the virtual keyboard or in the text box is mapped to address the respective character.

The user touches the area adjacent to and below a character displayed on the virtual keyboard or in the text box to select that character.

Similarly, the user can place a cursor in the space between two characters in the text box by touching the area below that space. Double tapping an area below a word in the text box selects that word. Sliding finger below a series of characters in the text box selects those characters.

### DETAILED DESCRIPTION OF THE INVENTION

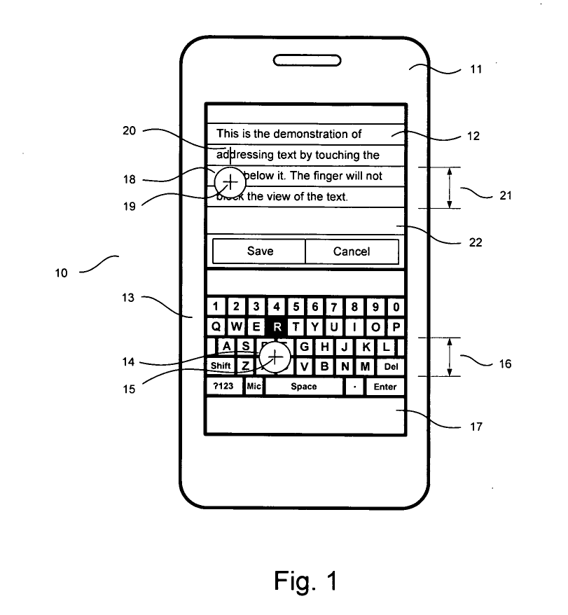

According to the first preferred embodiment of the invention, FIG. 1, there is a cell phone 10 with touch screen 11. Touch screen 11 displays text box 12 and virtual keyboard 13. Text entered by the user with virtual keyboard 13 is displayed in text box 12.

To select and enter a desired key, such as R key, into the text box, the user focuses on the desired key and touches the area below that key. The desired key changes visually to show the selection of the key. Then, the user lifts the finger and the selected key is entered into the text box. The touching and removing of the finger is called tapping.

Although the user touches other keys below the desired key, the registered position of the finger is mapped to only address and select the key immediately above the finger. Fingerprint 14 with its position coordinate mark 15 shows an instance of selecting the R key. Any position of the finger with a coordinate within the width of the R key and the height range 16 would select the same R key.

Thus, there is sufficient margin for vertical positioning of the finger. With uninterrupted view of the desired key, both horizontal and vertical positioning of the finger are naturally easy and accurate. The user can generally hit the correct location for a desired key in the first touch without the need to adjust finger position. As a result, accurate typing can be performed at a higher speed compared to using a conventional virtual keyboard.

There is a blank row 17 at the bottom of the virtual keyboard to select the keys in the bottom row.

Since the user focuses on the desired key, other keys below it would not interfere visually with the positioning of the finger.

Similarly, to address a character or location in text box 12 the user taps an area below that character or location. Fingerprint 18 with its position coordinate mark 19 shows an instance of placing cursor 20 between the two “d” characters in the word “addressing”. Any position of the finger with a coordinate within the width of desired character or location and the height range 21 would address the same character or location.

There is a blank row 22 at the bottom of the virtual keyboard to select the keys in the bottom row.

Although the user touches other characters below the desired character or position, the registered position of the finger is mapped to only address and select the character or position immediately above the finger.

Since the user focuses on the desired character or position, other characters below it would not interfere visually with the positioning of the finger.

Tapping finger under a character, selects and highlights that character for editing. Double tapping finger anywhere under a word, selects and highlights that word for editing. Sliding finger under a series of characters selects and highlights those characters for editing.

Selection of a key on the keyboard or a character in the text box, have basically same process of addressing a character displayed on the touch screen.

The first embodiment of the invention allows inclusion of extra rows of keys such as numeric keys in a cell phone without requiring extra space or compromising comfort and accuracy of typing.

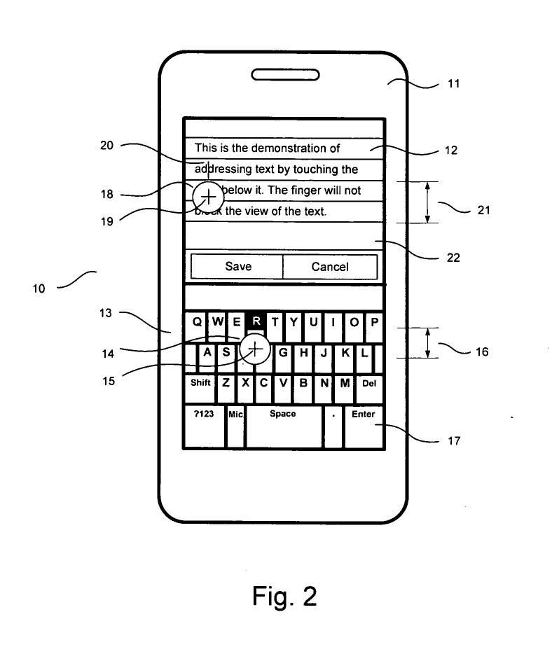

In the second embodiment of the invention, FIG. 2, there is a cell phone 10 with touch screen 11. Touch screen 11 displays text box 12 and virtual keyboard 13. Text entered by the user with virtual keyboard 13 is displayed in text box 12.

Each key image is extended vertically. The respective character is displayed on the upper portion of each key. To select and enter a desired key, such as R key, into the text box, the user touches the blank lower portion of the key. The key changes visually to confirm selection. The user lifts the finger to enter the key in text box 12.

To provide sufficient space for vertical positioning of the finger, the upper portion of each row of keys is included in the touch zone of the finger for the keys in the upper row. The fingerprint 14 with its position coordinate mark 15 shows an instance of selecting the R key. Any position of the finger with a coordinate within the width of the R key and the height range 16 would select the same R key.

The keys of the bottom row of the virtual keyboard 13 have longer vertical extension in area 17 to give them same touch space as the upper rows.

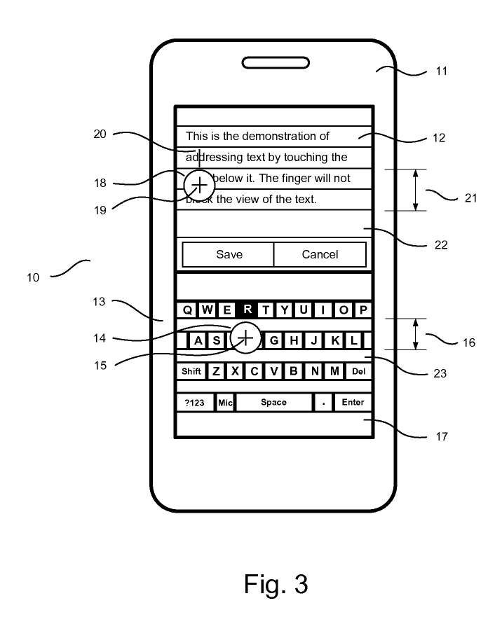

In the third embodiment of the invention, FIG. 3, there is a cell phone 10 with touch screen 11. Touch screen 11 displays text box 12 and virtual keyboard 13. Text entered by the user with virtual keyboard 13 is displayed in text box 12. There is a blank row 18 under each row of keys for addressing the keys above the blank row.

To select and enter a desired key, such as the R key, into the text box, the user touches the lower blank row 18 below the desired key. The key changes visually to show the selection. Then, the user lifts the finger and the selected key is entered in the text box.

Although the user may touch other keys below the blank row, the position of the finger is mapped to only address and select the key immediately above the finger. Fingerprint 14 with its position coordinate mark 15 shows an instance of selecting the R key. Any position of the finger with a coordinate within the width of the R key and the height range 16 would select the same R key.

In all embodiments, the finger blocks a larger area around the fingerprint. However, there is sufficient margin for positioning the finger to allow full view of the desired character or location.

The small virtual keyboard of the invention can be used in larger touch screens to reduce hand movement and increase typing speed.

I claim:

1. A touch screen text input and selection system for cell phones, computers, and electronic devices, comprising:
a touch screen integrated with a cell phone or computer,
the touch screen has a virtual keyboard and a text box to display the text inputted through the virtual keyboard,
an area adjacent to and below each character displayed on the virtual keyboard or in the text box is mapped to address the respective character,
the user touches the area adjacent to and below a character displayed on the virtual keyboard or in the text box to select that character,
thus, the user can select characters on the virtual keyboard for inputting, and in the text box for editing without blocking the view of characters by the touching finger.

2. The system of claim 1 wherein the addressing area of a character or key overlaps with the display area of an adjacent lower character or key.

3. The system of claim 1 having additional area below the bottom row of the virtual keyboard for addressing the keys of the bottom row.

4. The system of claim 1 wherein each key character is displayed on the upper portion of the respective key, the lower portion of the respective key provides target touch location for addressing the respective key.

5. The system of claim 1 having a blank area below each key to provide target touch location for addressing the respective key.

6. The system of claim 1 having additional area below the characters at the bottom of the text box to address those characters.

7. The system of claim 1 wherein a cursor is placed between two characters in the text box by touching between the addressing areas of the two characters.

8. The system of claim 1 wherein double tapping an addressing area below a word in the text box selects that word.

9. The system of claim 1 wherein sliding finger on the addressing area below a series of characters in the text box selects those characters.

10. A touch screen text input system for cell phones, computers, and electronic devices, comprising:
a touch screen integrated with a cell phone or computer,
the touch screen has a virtual keyboard and a text box to display the text inputted through the virtual keyboard,
an area adjacent to and below the character displayed on each key of the virtual keyboard is mapped to address the respective key,
the user touches the area adjacent to and below the character displayed on a desired key to select that key, and then removes the finger to input that key,
thus, the user can select a key on the virtual keyboard for inputting without blocking the view of the key by the touching finger.

11. The system of claim 10 wherein the addressing area of a key overlaps with the display area of an adjacent lower key.

12. The system of claim 10 having additional space below the bottom row of the keyboard for addressing the keys of the bottom row.

13. The system of claim 10 wherein each key character is displayed on the upper portion of the respective key, the lower portion of the respective key provides target touch location for addressing the respective key.

14. The system of claim 10 having a blank area below each key to provide target touch location for addressing the respective key.

15. A touch screen text selection system for cell phones, computers, and electronic devices, comprising:
a touch screen integrated with a cell phone or computer,
the touch screen has a virtual keyboard and a text box to display the text inputted through the virtual keyboard,
an area adjacent to and below each character displayed in the text box is mapped to address the respective character,
an area adjacent to and below the space between two characters displayed in the text box is mapped to address that space,
the user touches the area adjacent to and below a character displayed in the text box to select that character,
the user touches the area adjacent to and below the space between two characters displayed in the text box to place a cursor between the two characters,
thus, the user can select characters in the text box for editing without blocking the view of characters by the touching finger.

16. The system of claim 15 having additional area below the characters at the bottom of the text box to address those characters.

17. The system of claim 15 wherein the addressing area of a character overlaps with the display area of an adjacent lower character.

18. The system of claim 15 wherein double tapping an addressing area below a word in the text box selects that word.

19. The system of claim 15 wherein sliding finger on the addressing area below a series of characters in the text box selects those characters.
